(19) United States
(12) Patent Application Publication
(10) Pub. No.: US 2011/0142232 A1
(43) Pub. Date: Jun. 16, 2011

(54) SYSTEM AND METHOD FOR EFFECTIVE SCRAMBLING OR DESCRAMBLING

(75) Inventors: Chan Bok JEONG, Daejeon (KR); Gi Yoon PARK, Daejeon (KR); Daeho KIM, Daejeon (KR)

(73) Assignee: Electronics and Telecommunications Research Institute, Daejeon (KR)

(21) Appl. No.: 12/840,740

(22) Filed: Jul. 21, 2010

(30) Foreign Application Priority Data
Dec. 15, 2009 (KR) 10-2009-0124348

(51) Int. Cl. H04L 9/00

(52) U.S. Cl. 380/42

(57) ABSTRACT

Provided is an scrambling or descrambling method and apparatus. The scrambling system includes a data stream generating unit to generate data streams, a scrambling linear feedback shift register (LFSR) group to calculate a sequence output with respect to each of the generated data streams, and a scrambling processing unit to perform scrambling of the generated data streams based on the calculated sequence outputs. The descrambling system includes a data stream generating unit to generate scrambled data streams using scrambled data, a descrambling LFSR group to calculate a sequence output of each of the generated scrambled data streams, and a descrambling processing unit to perform descrambling of the scrambled data streams using the calculated sequence outputs.

### CROSS-REFERENCE TO RELATED APPLICATION

This application claims the benefit of Korean Patent Application No. 10-2009-0124348, filed on Dec. 15, 2009, in the Korean Intellectual Property Office, the disclosure of which is incorporated herein by reference.

### BACKGROUND

1. Field of the Invention

The present invention relates to an effective scrambling or descrambling method and system thereof.

2. Description of the Related Art

FIG. 1 illustrates a conventional scrambling scheme.

Referring to FIG. 1, with respect to a Linear Feedback Shift Register (LFSR), which has an initial loading vector as an initial value, and, to which a binary irreducible (primitive) polynomial is applied, the conventional scrambling scheme scrambles data streams using sequence output results including a sequence output result of an LFSR group that shifts the LFSR N times and a sequence output result being outputted every time the LFSR is further shifted after being shifted N times.

N may not be zero or may not be a great number, and thus, the scrambling scheme may shift the LFSR N times, and may shift the N times-shifted LFSR the same number of times as a length of the data streams to embody the scrambling.

For example, a Pseudo-random sequence defined in a Long Term Evolution (LTE)-Advanced Standard may be applied to the scrambling scheme. In this case, after the initial loading vector is initiated with respect to the LFSR, the scrambling scheme may perform scrambling of the data streams using the sequence output result of the LFSR group that shifts the LFSR N times and the sequence output result being outputted every time the LFSR is further shifted after being shifted N times.

However, according to the LTE-Advanced standard, N is 1600. Accordingly, it is difficult to embody the scrambling by shifting an LFSR 1600 times and further shifting the 1600 times-shifted LFSR the same number of times as a length of data streams. A plurality initial loading vectors exists, and thus, it is more difficult to generate a sequence output for each of the plurality of initial loading vectors and to perform scrambling during a limited time period.

FIG. 2 illustrates a conventional descrambling scheme.

Referring to FIG. 2, with respect to a LFSR, which has an initial loading vector as an initial value, and, to which a binary irreducible polynomial is applied, the conventional descrambling scheme descrambles scrambled data streams using sequence output results including a sequence output result of an LFSR group that shifts an LFSR N times and a sequence output result being outputted every time the LFSR is further shifted after being shifted N times.

N may be different from zero or may be different from a large number, and thus, the descrambling scheme may shift the LFSR N times, and may further shift the N times-shifted LFSR the same number of times as a length of the scrambled data streams to embody the descrambling.

For example, a Pseudo-random sequence defined in an LTE-Advanced Standard may be applied to the descrambling scheme. In this case, after the initial loading vector is initiated with respect to the LFSR, the descrambling scheme may perform descrambling of the scrambled data streams using the sequence output result of the LFSR group that shifts the LFSR N times and the sequence output result being outputted every time the LFSR is further shifted after being shifted N times.

However, according to the LTE-Advanced standard, N is 1600. Accordingly, it is difficult to embody the descrambling by shifting an LFSR 1600 times during a limited time and further shifting the 1600 times-shifted LFSR the same number of times as a length of the scrambled data streams. A plurality initial loading vectors exists, and thus, it is more difficult to generate a sequence output for each of the plurality of initial loading vectors and to perform descrambling during a limited time period.

### SUMMARY

An aspect of the present invention provides a scrambling or descrambling method and system that directly performs scrambling or descrambling without a time expended for shifting an LFSR N times, and thus, the scrambling or the descrambling may be performed during a limited time period.

Another aspect of the present invention also provides a scrambling or a descrambling method and system that effectively perform scrambling or descrambling in a LTE-Advanced system.

According to an aspect of the present invention, there is provided a scrambling system, and the scrambling system includes a data stream generating unit to generate data streams, a scrambling linear feedback shift register (LFSR) group to calculate a sequence output with respect to each of the generated data streams, and a scrambling processing unit to perform scrambling of the generated data streams based on the calculated sequence outputs.

The scrambling LFSR group may include at least one LFSR, and each of the at least one LFSR may apply a binary irreducible polynomial to an initial loading vector, may calculate a state value of an N times shifted, N being a natural number, and may use the calculated state value as the initial loading vector to calculate the sequence output.

According to another aspect of the present invention, there is provided a descrambling system, and the descrambling system includes a data stream generating unit to generate scrambled data streams using scrambled data, a descrambling LFSR group to calculate a sequence output of each of the generated scrambled data streams, and a descrambling processing unit to perform descrambling of the scrambled data streams using the calculated sequence outputs.

According to another aspect of the present invention, there is provided a scrambling method, and the method includes synchronizing with a clock and generating data streams using data to be scrambled, based on an n-bit unit, n being a number of bits to be scrambled, calculating a sequence output with respect to each of the generated data streams, and scrambling the generated data streams based on the calculated sequence outputs.

According to another aspect of the present invention, there is provided a descrambling method, and the method includes generating scrambled data streams using scrambled data, calculating a sequence output of each of the generated scrambled data streams, and descrambling the scrambled data streams using the calculated sequence outputs.

Additional aspects, features, and/or advantages of the invention will be set forth in part in the description which follows and, in part, will be apparent from the description, or may be learned by practice of the invention.

### EFFECT

According to an embodiment, a scrambling or descrambling method and system that directly performs scrambling or descrambling without a time expended for shifting an LFSR N times, and thus, the scrambling or the descrambling may be sequentially performed a plurality of times during a relatively short time period, expended resources and energy may be also reduced.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating a conventional scrambling scheme;

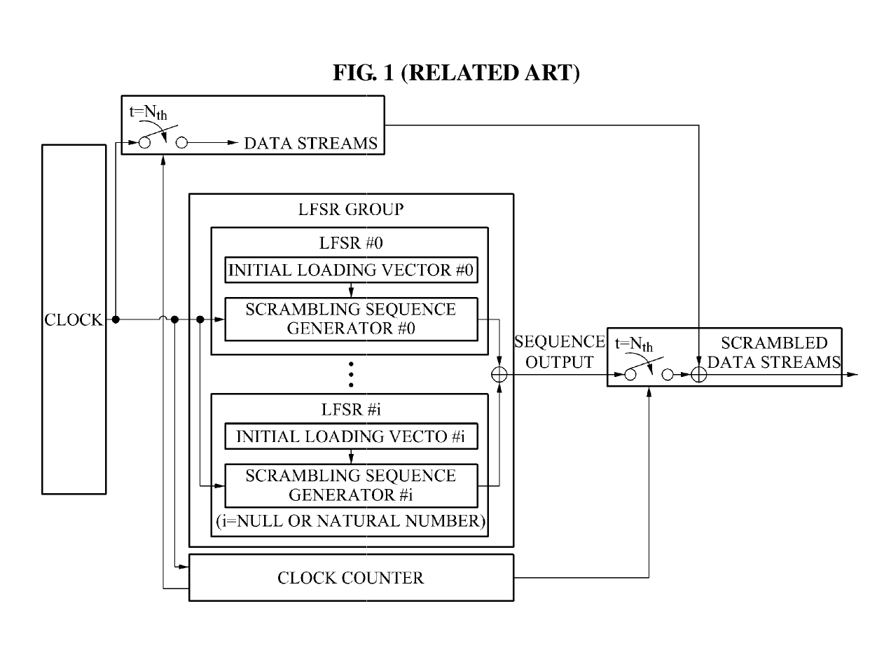

FIG. 2 is a block diagram illustrating a conventional descrambling scheme;

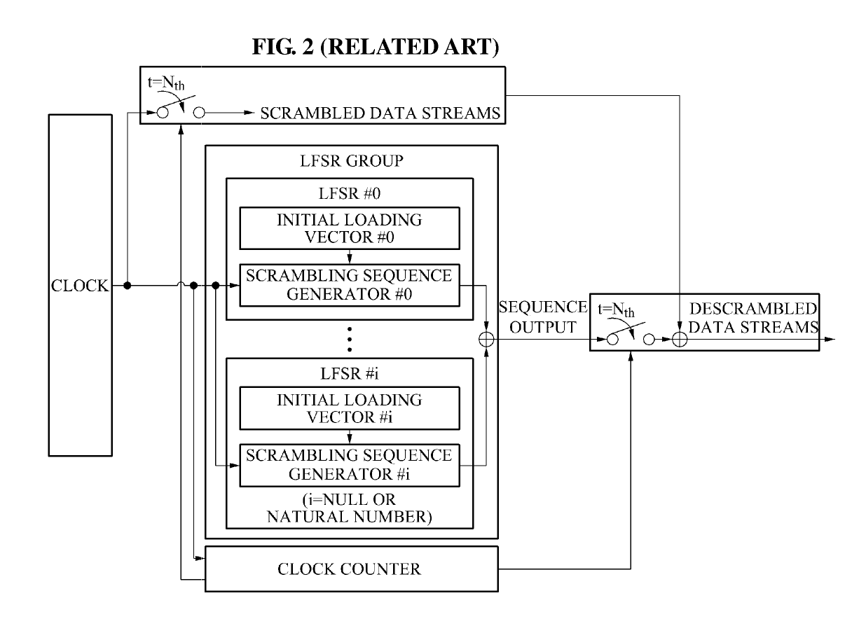

FIG. 3 is a block diagram illustrating a scrambling system according to an embodiment of the present invention;

FIG. 4 is a diagram illustrating an example of calculating a state value of a LFSR of an LTE-Advanced system; and

FIG. 5 is a diagram illustrating a descrambling system according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

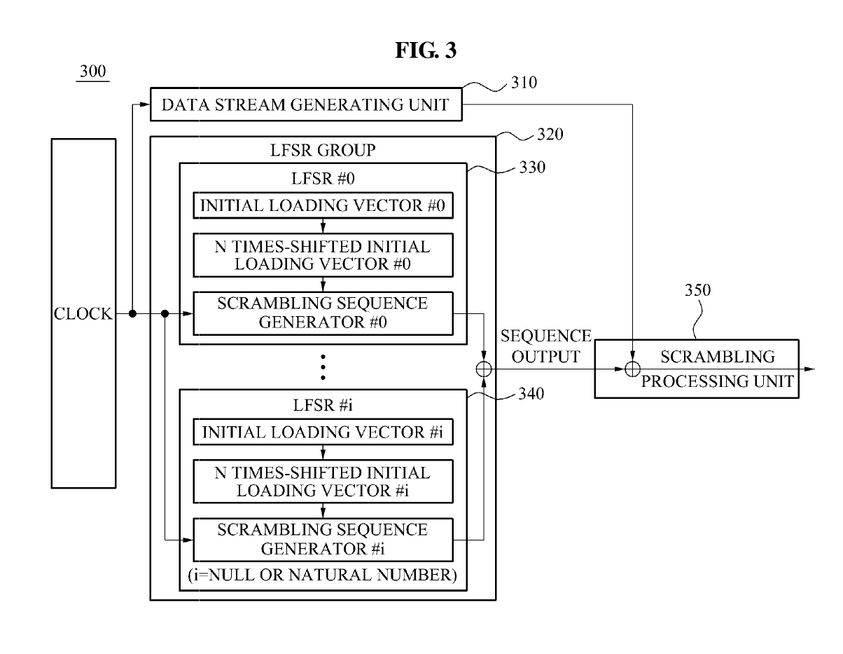

FIG. 3 illustrates a scrambling system 300 according to an embodiment of the present invention.

Referring to FIG. 3, the scrambling system 300 may include a data stream generating unit 310, a Linear Feedback Shift Register (LFSR) group 320 or a scrambling LFSR group, LFSRs 330 and 340, and a scrambling processing unit 350.

The data stream generating unit 310 may generate data streams. Specifically, the data stream generating unit 310 may be synchronized with a clock, and may generate the data streams using data to be scrambled, based on an n-bit unit, n being a number of bits to be scrambled based on a clock unit. For example, the data stream generating unit 310 may generate data streams based on a one-bit unit or based on a four-bit unit.

The LFSR group 320 may calculate a sequence output for each of the generated data streams. The LFSR group 320 may calculate the sequence output based on an n-bit unit, n being a number of bits to be scrambled based on a clock unit. For example, the LFSR group 320 may calculate the sequence output based on a one-bit unit or based on a four-bit unit.

Specifically, the LFSR group 320 may include at least one LFSR. Each of the LFSR 330 and the LFSR 340 may apply a binary irreducible (primitive) polynomial to an initial loading vector, may calculate a state value of an N times shifted, N being a natural number, and may use the calculated state value as the initial loading vector to calculate the sequence output. For example, each of the LFSRs 330 and 340 may include a Simple Shift Register Generator (SSRG) or a Modular Shift Register Generator (MSRG).

According to an embodiment, the LFSR group 320 may apply a one-bit unit based scrambling sequence generator or may apply a four-bit unit based scrambling sequence generator, with respect to a Pseudo-random sequence generator defined in a Third Generation Partnership Project (3GPP) LTE-Advanced Standard.

The LFSR 330 may be predictable based on the LTE-Advanced Standard, and thus, may be used as a default scheme, as illustrated below.

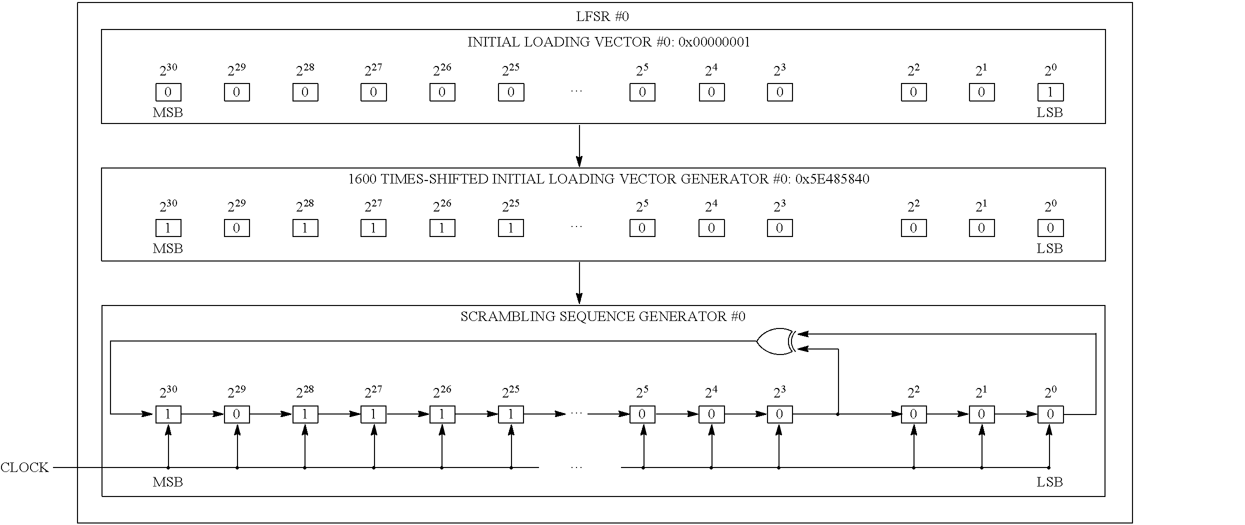

The LFSR 340 may have a variable initial loading vector, and thus, may use an N times-shifted initial loading vector generator as illustrated below.

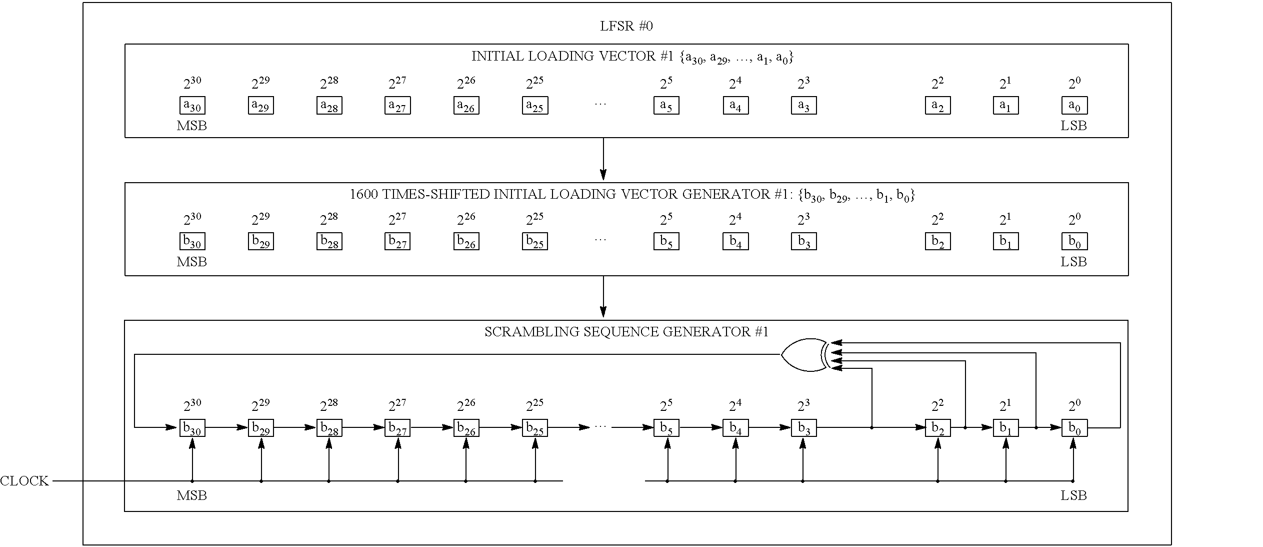

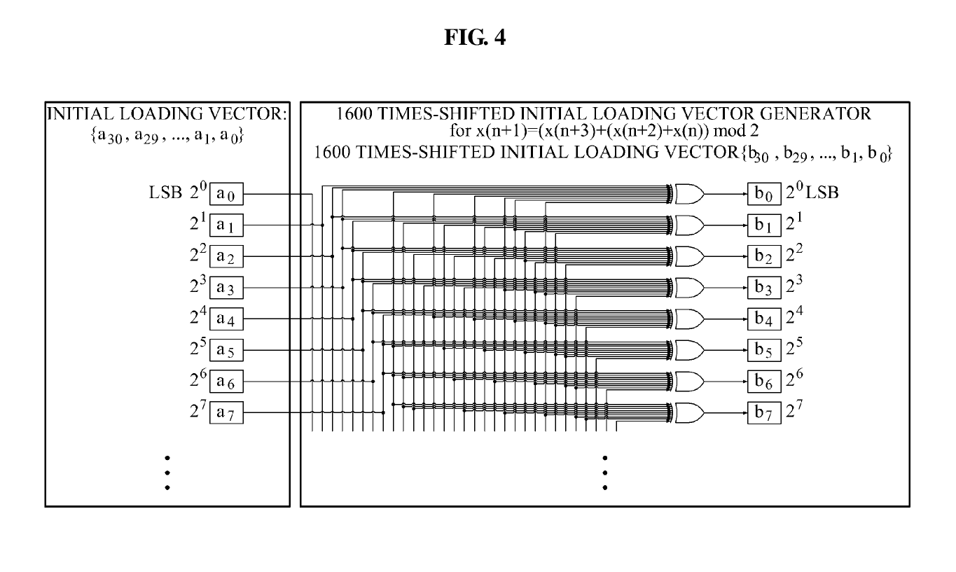

FIG. 4 illustrates an example of calculating a state value of a LFSR of an LTE-Advanced system.

Referring to FIG. 4, the LFSR group 320 may calculate a state value of an 1600 times shifted with respect to each of the LFSRs 330 and 340, with respect to a Pseudo-random sequence defined in an LTE-Advanced Standard. Each of the LFSR 330 and the LFSR 340 uses an initial loading vector as an initial value and has x(n+31)=(x(n+3)+x(n+2)+x(n+1)+x(n)) mod 2 as a irreducible polynomial.

According to an embodiment, the LFSR group 320 may calculate the state value of the 1600 times shifted based on Equation 1.

initial loading vector={a₃₀, a₂₉, . . . a₁, a₀}

1600 times-shifted initial loading vector={b₃₀, b₂₉, . . . b₁, b₀}

b₀=a₂₃⊕a₂₀⊕a₁₉⊕a₁₆⊕a₁₂⊕a₈⊕a₃⊕a₂⊕a₁,

b₁=a₂₄⊕a₂₁⊕a₂₀⊕a₁₇⊕a₁₃⊕a₉⊕a₄⊕a₃⊕a₂,

b₂=a₂₅⊕a₂₂⊕a₂₁⊕a₁₈⊕a₁₄⊕a₁₀⊕a₅⊕a₄⊕a₃,

b₃=a₂₆⊕a₂₃⊕a₂₂⊕a₁₉⊕a₁₅⊕a₁₁⊕a₆⊕a₅⊕a₄,

b₄=a₂₇⊕a₂₄⊕a₂₃⊕a₂₀⊕a₁₆⊕a₁₂⊕a₇⊕a₆⊕a₅,

b₅=a₂₈⊕a₂₅⊕a₂₄⊕a₂₁⊕a₁₇⊕a₁₃⊕a₈⊕a₇⊕a₆,

b₆=a₂₉⊕a₂₆⊕a₂₅⊕a₂₂⊕a₁₈⊕a₁₄⊕a₉⊕a₈⊕a₇,

b₇=a₃₀⊕a₂₇⊕a₂₆⊕a₂₃⊕a₁₉⊕a₁₅⊕a₁₀⊕a₉⊕a₈,

b₈=a₂₈⊕a₂₇⊕a₂₄⊕a₂₀⊕a₁₆⊕a₁₁⊕a₁₀⊕a₉⊕a₃⊕a₂⊕a₁⊕a₀,

b₉=a₂₉⊕a₂₈⊕a₂₅⊕a₂₁⊕a₁₇⊕a₁₂⊕a₁₁⊕a₁₀⊕a₄⊕a₃⊕a₂⊕a₁,

b₁₀=a₃₀⊕a₂₉⊕a₂₆⊕a₂₂⊕a₁₈⊕a₁₃⊕a₁₂⊕a₁₁⊕a₅⊕a₄⊕a₃⊕a₂,

b₁₁=a₃₀⊕a₂₇⊕a₂₃⊕a₁₉⊕a₁₄⊕a₁₃⊕a₁₂⊕a₆⊕a₅⊕a₄⊕a₂⊕a₁⊕a₀,

b₁₂=a₂₈⊕a₂₄⊕a₂₀⊕a₁₅⊕a₁₄⊕a₁₃⊕a₇⊕a₆⊕a₅⊕a₀,

b₁₃=a₂₉⊕a₂₅⊕a₂₁⊕a₁₆⊕a₁₅⊕a₁₄⊕a₈⊕a₇⊕a₆⊕a₁,

b₁₄=a₃₀⊕a₂₆⊕a₂₂⊕a₁₇⊕a₁₆⊕a₁₅⊕a₉⊕a₈⊕a₇⊕a₂,

b₁₅=a₂₇⊕a₂₃⊕a₁₈⊕a₁₇⊕a₁₆⊕a₁₀⊕a₉⊕a₈⊕a₂⊕a₁⊕a₀,

b₁₆=a₂₈⊕a₂₄⊕a₁₉⊕a₁₈⊕a₁₇⊕a₁₁⊕a₁₀⊕a₉⊕a₃⊕a₂⊕a₁,

b₁₇=a₂₉⊕a₂₅⊕a₂₀⊕a₁₉⊕a₁₈⊕a₁₂⊕a₁₁⊕a₁₀⊕a₄⊕a₃⊕a₂,

b₁₈=a₃₀⊕a₂₁⊕a₂₀⊕a₁₉⊕a₁₃⊕a₁₂⊕a₁₁⊕a₅⊕a₄⊕a₃,

b₁₉=a₂₇⊕a₂₂⊕a₂₁⊕a₂₀⊕a₁₄⊕a₁₃⊕a₁₂⊕a₆⊕a₅⊕a₄⊕a₃⊕a₁⊕a₀,

b₂₀=a₂₈⊕a₂₃⊕a₂₂⊕a₂₁⊕a₁₅⊕a₁₄⊕a₁₃⊕a₇⊕a₆⊕a₅⊕a₄⊕a₃⊕a₂⊕a₁,

b₂₁=a₂₉⊕a₂₄⊕a₂₃⊕a₂₂⊕a₁₆⊕a₁₅⊕a₁₄⊕a₈⊕a₇⊕a₆⊕a₅⊕a₄⊕a₃⊕a₂,

b₂₂=a₃₀⊕a₂₅⊕a₂₄⊕a₂₃⊕a₁₇⊕a₁₆⊕a₁₅⊕a₉⊕a₈⊕a₇⊕a₆⊕a₅⊕a₄⊕a₃,

b₂₃=a₂₆⊕a₂₅⊕a₂₄⊕a₁₈⊕a₁₇⊕a₁₆⊕a₁₀⊕a₉⊕a₈⊕a₇⊕a₆⊕a₅⊕a₄⊕a₃⊕a₂⊕a₁⊕a₀,

b₂₄=a₂₇⊕a₂₆⊕a₂₅⊕a₁₉⊕a₁₈⊕a₁₇⊕a₁₁⊕a₁₀⊕a₉⊕a₈⊕a₇⊕a₆⊕a₅⊕a₄⊕a₃⊕a₂⊕a₁,

b₂₅=a₂₈⊕a₂₇⊕a₂₅⊕a₂₀⊕a₁₉⊕a₁₈⊕a₁₂⊕a₁₁⊕a₁₀⊕a₉⊕a₈⊕a₇⊕a₆⊕a₅⊕a₄⊕a₃⊕a₂,

b₂₆=a₂₉⊕a₂₈⊕a₂₇⊕a₂₁⊕a₂₀⊕a₁₉⊕a₁₃⊕a₁₂⊕a₁₁⊕a₁₀⊕a₉⊕a₈⊕a₇⊕a₆⊕a₅⊕a₄⊕a₃,

b₂₇=a₃₀⊕a₂₉⊕a₂₈⊕a₂₂⊕a₂₁⊕a₂₀⊕a₁₄⊕a₁₃⊕a₁₂⊕a₁₁⊕a₁₀⊕a₉⊕a₈⊕a₇⊕a₆⊕a₅⊕a₄,

b₂₈=a₃₀⊕a₂₉⊕a₂₃⊕a₂₂⊕a₂₁⊕a₁₅⊕a₁₄⊕a₁₃⊕a₁₂⊕a₁₁⊕a₁₀⊕a₉⊕a₈⊕a₇⊕a₆⊕a₅⊕a₃⊕a₂⊕a₁⊕a₀,

b₂₉=a₃₀⊕a₂₄⊕a₂₃⊕a₂₂⊕a₁₆⊕a₁₅⊕a₁₄⊕a₁₃⊕a₁₂⊕a₁₁⊕a₁₀⊕a₉⊕a₈⊕a₇⊕a₆⊕a₄⊕a₀,

b₃₀=a₂₅⊕a₂₄⊕a₂₃⊕a₁₇⊕a₁₆⊕a₁₅⊕a₁₄⊕a₁₃⊕a₁₂⊕a₁₁⊕a₁₀⊕a₉⊕a₈⊕a₇⊕a₅⊕a₃⊕a₂⊕a₀ [Equation 1]

The scrambling processing unit 350 may perform scrambling of the data streams generated based on the calculated sequence output. The scrambling processing unit 350 may scramble the data streams using the sequence output based on an n-bit unit, n being a number of bits to be scrambled based on a clock unit. For example, the scrambling processing unit 350 may scramble the data streams based on a one-bit unit or based on a four-bit unit.

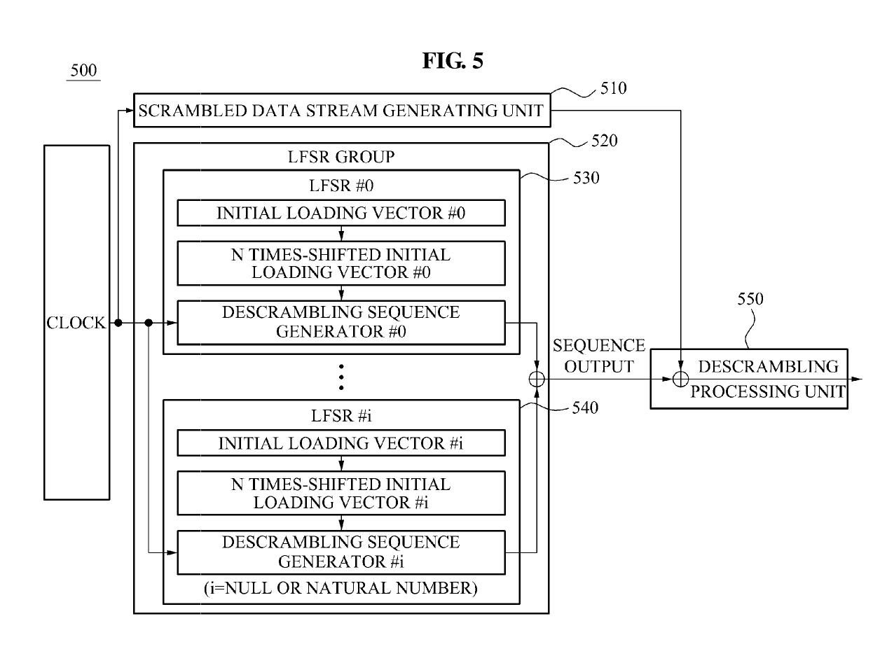

FIG. 5 illustrates a descrambling system according to an embodiment of the present invention.

Referring to FIG. 5, the descrambling system 500 may include a scrambled data stream generating unit 510, an LFSR group 520 or a descrambling LFSR group, an LFSRs 530 and 540, and a descrambling processing unit 550.

The scrambled data stream generating unit 510 may generate scrambled data streams based on scrambled data. The scrambled data stream generating unit 510 may be synchronized with a clock, and may generate the scrambled data streams using the scrambled data to be descrambled, based on an n-bit unit, n being a number of bits to be descrambled based on a clock unit. For example, the scrambled data stream generating unit 510 may generate scrambled data steams based on a one-bit unit or based on a four-bit unit.

The LFSR group 520 may calculate a sequence output with respect to each of the generated scrambled data streams. According to an embodiment, the LFSR group 520 may calculate the sequence output based on an n-bit unit, n being a number of bits to be descrambled based on a clock unit. For example, the LFSR group 520 may calculate a sequence output based on a one-bit unit or based on a four-bit unit.

Specifically, the LFSR group 520 may include at least one LFSR. Each of the LFSR 530 and the LFSR 540 may apply a binary irreducible polynomial to an initial loading vector, may calculate an state value of an N times shifted, and may use the calculated state value as the initial loading vector to calculate the sequence output of the LFSR group 520. Similarly, each of the LFSRs 530 and 540 may include an SSRG or an MSRG. Each of the LFSRs 530 and 540 may calculate a sequence output based on a one-bit unit or based on a four-bit unit.

According to an embodiment, an LFSR group 520 may apply a one-bit unit based descrambling sequence generator or may apply a four-bit unit based descrambling sequence generator with respect to a Pseudo-random sequence generator defined in the 3GPP LTE-Advanced Standard. The LFSR 530 may be predictable based on the LTE-Advanced Standard and thus, may be used as a default scheme. The LFSR 540 may have a variable initial loading vector, and thus, may use an N times-shifted initial loading vector generator.

The descrambling processing unit 550 may descramble the scrambled data streams using the calculated sequence output. The descrambling processing unit 550 may descramble the scrambled data streams using the sequence output, based on an n-bit unit, n being a number of bits to be descrambled based on a clock unit. For example, the descrambling processing unit 550 may descramble the scrambled data streams based on a one-bit unit or based on a four-bit unit.

The method according to the above-described embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A scrambling system, comprising:
a data stream generating unit to generate data streams;
a scrambling linear feedback shift register (LFSR) group to calculate a sequence output with respect to each of the generated data streams; and
a scrambling processing unit to perform scrambling of the generated data streams based on the calculated sequence outputs.

2. The scrambling system of claim 1, wherein the data stream generating unit generates the data streams, using data to be scrambled, based on an n-bit unit, n being a number of bits to be scrambled based on a clock unit.

3. The scrambling system of claim 1, wherein:
the scrambling LFSR group includes at least one LFSR; and
each of the at least one LFSR applies a binary irreducible polynomial to an initial loading vector, calculates a state value of an N times shifted, N being a natural number, and uses the calculated state value as the initial loading vector to calculate the sequence output.

4. The scrambling system of claim 3, wherein the scrambling LFSR group calculates the sequence output based on an n-bit unit, n being a number of bits to be scrambled based on a clock unit.

5. The scrambling system of claim 3, wherein the LFST includes a simple shift register generator (SSRG) or a modular shift register generator (MSRG).

6. The scrambling system of claim 1, wherein the scrambling processing unit performs scrambling of the data streams using the sequence outputs based on an n-bit unit, n being a number of bits to be scrambled based on a clock unit.

7. A descrambling system, comprising:
a data stream generating unit to generate scrambled data streams using scrambled data;
a descrambling LFSR group to calculate a sequence output of each of the generated scrambled data streams; and
a descrambling processing unit to perform descrambling of the scrambled data streams using the calculated sequence outputs.

8. The descrambling system of claim 7, wherein the scrambled data stream generating unit generates the scrambled data streams using scrambled data to be descrambled, based on an n-bit unit, n being a number of bits to be descrambled based on a clock unit.

9. The descrambling system of claim 7, wherein:
the descrambling LFSR group includes at least one LFSR; and
each of the least one LFSR applies a binary irreducible polynomial to an initial loading vector, calculates a state value of an N times shifted, N being a natural number, and uses the calculated state value as the initial loading vector to calculate the sequence output.

10. The descrambling system of claim 7, wherein the descrambling processing unit descrambles the scrambled data streams using the sequence outputs, based on an n-bit unit, n being a number of bits to be descrambled based on a clock unit.

11. A scrambling method, the method comprising:
synchronizing with a clock and generating data streams using data to be scrambled, based on an n-bit unit, n being a number of bits to be scrambled;
calculating a sequence output with respect to each of the generated data streams; and
scrambling the generated data streams based on the calculated sequence outputs.

12. The method of claim 11, wherein the calculating comprises:
calculating the sequence output based on an n-bit unit, n being a number of bits to be scrambled based on a clock unit.

13. The method of claim 11, wherein the calculating comprises:
applying a binary irreducible polynomial to an initial loading vector using at least one LFSR;
calculating a state value of an N times shifted-LFSR, N being a natural number; and
calculating the sequence output using the calculated state value as the initial loading vector.

14. The method of claim 13, wherein the scrambling comprises:
scrambling the data streams using the sequence outputs, based on an n-bit unit, n being a number of bits to be scrambled based on a clock unit.

15. A descrambling method, the method comprising:
generating scrambled data streams using scrambled data;
calculating a sequence output of each of the generated scrambled data streams; and
descrambling the scrambled data streams using the calculated sequence outputs.

16. The method of claim 15, wherein the generating comprises:
generating the scrambled data streams using scrambled data to be descrambled, based on an n-bit unit, n being a number of bits to the descrambled based on a clock unit.

17. The method of claim 15, wherein the descrambling comprises:
descrambling the scrambled data streams using the sequence outputs, based on an n-bit unit, n being a number of bits to be descrambled based on a clock unit.
